(19) United States
(12) Patent Application Publication
(10) Pub. No.: US 2009/0236928 A1
(43) Pub. Date: Sep. 24, 2009

(54) ELECTRICAL MACHINE

(76) Inventor: Achim Hawighorst, Buehlertal (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/280,837

(22) PCT Filed: Jan. 16, 2007
(86) PCT No.: PCT/EP07/50397

§ 371 Date: Aug. 27, 2008

(30) Foreign Application Priority Data
Mar. 14, 2006 (DE) 10 2006 011 601.1

(51) Int. Cl. H02K 3/28; H02K 13/00

(52) U.S. Cl. 310/208; 310/233

(57) ABSTRACT

The invention describes an electrical machine having an armature with armature slots for accommodating armature coils, and a commutator with commutator laminates. At least one armature coil is formed from two coil elements, which are arranged symmetrically with respect to one another in relation to the axis of rotation of the armature. The electrical machine is designed such that the number of commutator laminates is an integral multiple of the number of armature slots.

### PRIOR ART

The invention relates to an electrical machine, in particular a DC machine, according to the preamble to claim 1.

WO 2005/076442 A has disclosed an electric motor with a symmetrically arranged armature winding. The symmetrically arranged armature winding is composed of a first coil that is wound between two arbitrary armature slots and is electrically connected to adjacent commutator plates. A second coil is wound between two armature slots, which are situated centrosymmetrically to the two armature slots of the first coil in relation to the center point of the armature shaft, and is wound in the opposite direction. In the motor, the number of armature slots is equal to the number of commutator plates. The motor has one brush each for high and low speeds and also has a shared brush. The first and second coils are arranged so that they are situated in a position symmetrical to an axis that passes through the center point of the brush for high speeds and the center point of the rotary shaft when the brush for high speeds comes into contact with the adjacent commutator plate and thus short-circuits the first coil with the second coil.

### DISCLOSURE OF THE INVENTION

The electrical machine according to the invention, with the defining characteristics of claim 1, has an improved noise reduction and an improved electromagnetic compatibility (EMC). This is achieved by virtue of the fact that the electrical machine according to the invention has an armature winding composed of armature coils, at least one armature coil being composed of two partial coils that are arranged symmetrically in relation to the rotation axis of the armature. This means that the armature coils are embodied so that the two partial coils of each pair are arranged symmetrically to each other in relation to the rotation axis of the armature. According to the invention, the number of commutator plates is an integral multiple of the number of armature slots. In particular, the number of commutator plates is at least twice as great as the number of armature slots. It is preferable for the number of commutator plates to be twice as great as the number of armature slots. The number of plates, however, can also be, for example, three times the number of armature slots. In addition, the commutator preferably has an even number of commutator plates.

According to the invention, the two partial coils are arranged symmetrically to each other so that when current is supplied to the partial coils, essentially no radial forces act on the armature in a magnetic field. The two partial coils can be commutated simultaneously, for example by being connected to adjacent commutator plates. The resulting radial forces are compensated for in a particularly favorable fashion in that the two partial coils are arranged essentially parallel to each other geometrically and spaced the same distance apart from the rotation axis of the armature. The radial forces can also be compensated for particularly well in that the two partial coils have the same number of windings. It is furthermore possible to compensate for radial forces in a particularly fashion in that the two partial coils are wound in opposite winding directions from each other. The two partial coils arranged symmetrically to each other are referred to below as a partial coil pair. In particular, this is a two-poled electrical winding.

The two symmetrically arranged partial coils are preferably wound in the fashion of a fractional pitch winding, but can also be wound in the fashion of a full-pitch diametrical winding.

With a multiple number of commutator plates, a corresponding multiple number of partial coils is wound into each armature slot. Thus, for example, with twice the number of plates, two partial coils (each being a partial coil of a partial coil pair) are wound into one armature slot and with three times the number of plates, three partial coils (likewise each being a partial coil of a partial coil pair) are wound into one armature slot. This means that one armature slot contains two or three partial coils of two or three partial coil pairs. With a given slot area, this can, for example, be achieved by means of a correspondingly lower number of windings per partial coil or by means of a smaller coil wire cross section, the former being accompanied by a change in the speed and the latter being accompanied by a change in the output.

The two partial coils of a partial coil pair can be electrically connected to each other either in series or in parallel. With the series connection, the two partial coils have two ends that are each electrically connected to a respective commutator plate. If twice the number of commutator plates are provided, then the two ends of the two series-connected partial coils are each electrically connected to a respective commutator plate that is spaced one plate away from the other. Thus, for example, the first end of a first partial coil pair is connected to a first commutator plate and the second end of the first partial coil pair is connected to the plate spaced one plate away from the first, i.e. the third commutator plate. The second commutator plate situated between them is connected to the first end of a second partial coil pair and the second end of the second partial coil pair is in turn connected to the plate spaced one plate away it, i.e., the fourth commutator plate in this case. This connection of the two ends of a series-connected partial coil pair continues in corresponding fashion until all of the armature slots are occupied by symmetrically arranged partial coils. If three times the number of commutator plates are provided, then the two ends of the series-connected partial coils are each electrically connected in an analogous fashion to the respective commutator plate that is the third plate in relation to the other. This means that, for example, the first end of a first partial coil pair is connected to a first commutator plate and the second end of the first partial coil pair is connected to the fourth commutator plate. The first end of a second partial coil pair is thus connected to the second commutator plate and the second end of the second partial coil pair is connected to the fifth commutator plate. In addition, the first end of a third partial coil pair is connected to the third commutator plate and the second end of the third partial coil pair is connected to the sixth commutator plate.

With the parallel connection, however, each of the two partial coils of a partial coil pair has two ends so that for each partial coil pair, four ends are connected to the commutator plates in an electrically conductive fashion. With twice the number of commutator plates, the ends of the two partial coils are connected to adjacent commutator plates in alternating fashion. This means that the second end of one partial coil is respectively connected to the commutator plate spaced one away from the other. Thus, for example, the first end of a first partial coil is connected to a first commutator plate and the second end of the first partial coil is connected to the one after the next, i.e. the third commutator plate, while the first end of the second partial coil is connected to the second commutator plate and the second end of the second partial coil is connected to the fourth commutator plate.

The electrical machine according to the invention has at least two brushes that rest against the commutator in sliding fashion. For example, the two brushes are situated opposite each other. In order to assure the most uniform possible flow of current during commutation, the brush width is selected so that during rotation of the commutator, the respective plates that are connected to the two partial coils are short-circuited. It is also possible, however, to select a different brush width, e.g. 1.2 times the width of a commutator plate.

In the electrical machine according to the invention, it is also possible for speed adjustment purposes to provide a third brush that is situated radially between the brushes that are situated opposite each other (referred to below as the first and second brushes). The third brush is thus arranged offset in relation to the first brush by a certain angle of less than 180°, e.g. 70°, in the rotation direction. In this case, in the low speed stage, the two brushes situated opposite each other, i.e. the first and second brushes, are supplied with current while the third brush is without current. In the high speed stage, the second and third brushes are supplied with current whereas the first brush is without current. The second brush therefore constitutes the shared brush, which cooperates with the first brush at low speeds and cooperates with the third brush at high speeds.

In another preferred embodiment, the symmetrically arranged partial coils are embodied in two layers, in the form of a double winding with a reduced, i.e. halved, coil wire cross section. This makes it possible to achieve an increased slot space factor.

The electrical machine according to the invention can, for example, be a two-poled DC motor for adjusting moving components in a motor vehicle, e.g. a windshield wiper motor, a power window motor, or a seat adjusting motor.

The invention will be explained in greater detail below in conjunction with the accompanying drawings.

### DRAWINGS

FIG. 1 shows an electrical machine with two brushes

FIG. 2 shows a first embodiment of armature coils having two symmetrical partial coils with a fractional pitch winding arranged in a series circuit,

FIG. 3 shows a second embodiment of armature coils having two symmetrical partial coils with a fractional pitch winding arranged in a parallel circuit,

FIG. 4 shows a third embodiment of armature coils having two symmetrical partial coils with a full-pitch diametrical winding, and

FIG. 5 shows a fourth embodiment with three times the number of commutator plates.

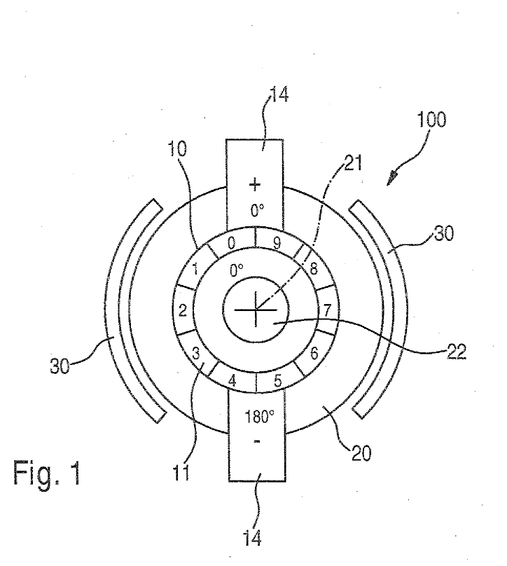

FIG. 1 shows an electrical machine 100, which has an armature 20, two magnetic poles 30, and a commutator 10 with commutator plates 11. The armature 20 and the commutator 10 are supported in a rotationally fixed fashion on an armature shaft 22 with a rotation axis 21. A first and second brush 14 are arranged opposite each other, resting against the commutator 10 in sliding fashion.

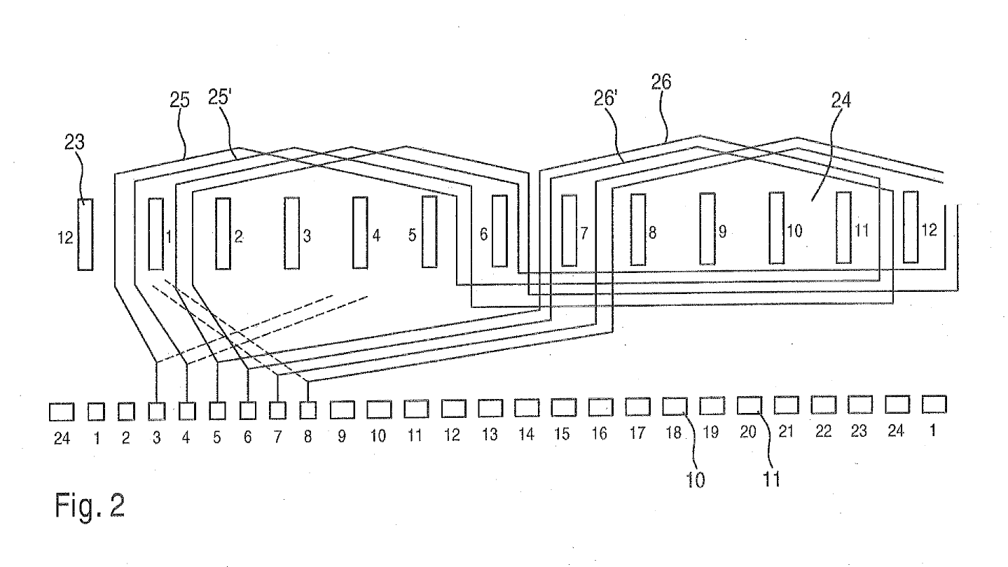

FIG. 2 schematically depicts a partial developed view of a first embodiment of armature coils, each with two symmetrical partial coils. In the embodiment shown, the commutator 10 has 24 plates 11 and the armature 20 has twelve teeth 23 and twelve armature slots 24. The armature coil is wound in the fashion of a multiple circuit winding in the form of a fractional pitch winding. A first partial coil pair 25, 26 is wound as follows: the winding of a first partial coil 25 is situated in a first armature slot 24 between the twelfth and first teeth 23 and in the sixth armature slot 24 between the fifth and sixth teeth 23. The winding of a second partial coil 26 is situated in the twelfth armature slot 24 between the eleventh and twelfth teeth 23 and in the seventh armature slot 24 between the sixth and seventh teeth 23. The two ends of the first and second partial coils 25, 26 are each electrically connected to the respective commutator plate 11 spaced one apart from the other (in this case, the third and fifth plates). The two partial coils 25, 26 are thus connected in series. The first and sixth armature slots 24 and the seventh and twelfth armature slots 24 are respectively situated opposite each other so that the two partial coils 25, 26 are arranged symmetrically to each other in relation to the rotation axis 13 of the armature 20. The partial coils 25, 26 run parallel to each other, with the two partial coils 25, 26 being wound in opposite winding directions. In the embodiment shown, the first partial coil 25 is wound first before the second partial coil 26 is wound. Alternatively, however, it is also possible for the two partial coils 25, 26 to be wound in alternation.

The first partial coil 25′ of a second partial coil pair 25′, 26′ is likewise situated in the first and sixth armature slots 24 while the second partial coil 26′ of the second partial coil pair 25′, 26′ is situated in the twelfth and seventh armature slots 24. The two ends in turn are each connected to a respective commutator plate 11 spaced one apart from the other, the first end of the second partial coil pair in this case being connected to the fourth commutator plate 11 and the second end being connected to the sixth commutator plate 11. Correspondingly, the other armature slots 24 are also each occupied by two respective first partial coils 25 or second partial coils 26 of two partial coil pairs 25, 26, the two ends of one partial coil pair 25, 26 each being connected to a respective commutator plate 11 spaced one apart from the other (e.g. the third and fifth plates and the fourth and sixth plates, respectively). This means that the four ends of two partial coil pairs 25, 26 and 25′, 26′, which are situated in the same armature slots 24, are each connected to a respective commutator plate 11 in alternating fashion.

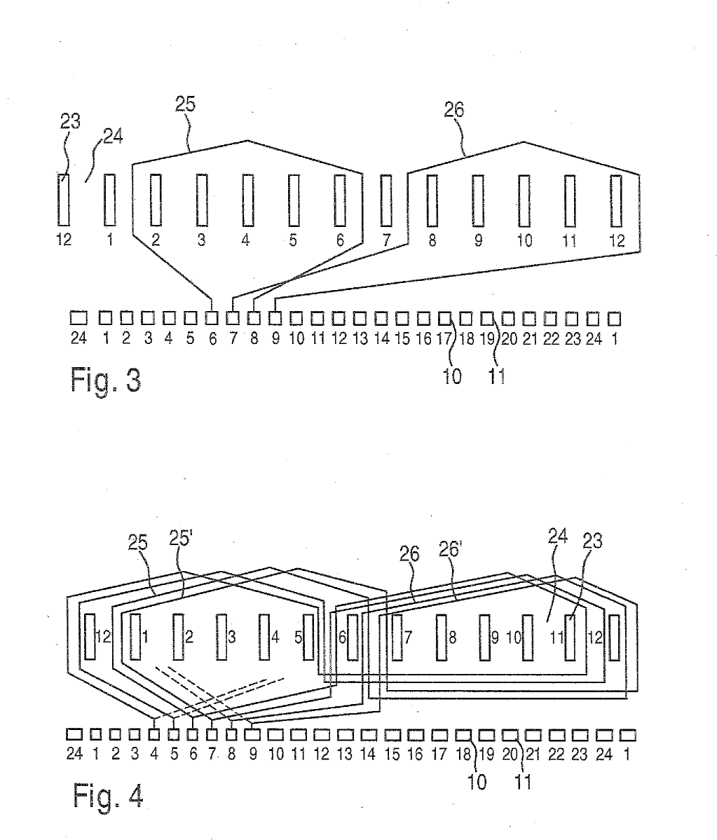

FIG. 3 schematically depicts a partial developed view of a second embodiment of armature coils, each with two respective symmetrical partial coils 25, 26 and 25′, 26′ of two partial coil pairs. In the embodiment shown, the commutator 10 once again has 24 plates 11 and the armature 20 has twelve teeth 23 and twelve armature slots 24. The armature coil is likewise wound in the fashion of a multiple circuit winding in the form of a fractional pitch winding. The winding of a first partial coil 25 of a first partial coil pair 25, 26 is situated in the second armature slot 24 between the first and second teeth 23 and in the seventh armature slot 24 between the sixth and seventh teeth 23. The winding of a second partial coil 26 of the first partial coil pair 25, 26 is situated in the first armature slot 24 between the twelfth and first teeth 23 and in the eighth armature slot 24 between the seventh and eighth teeth 23. The two partial coils 25, 26 are connected in parallel in that the two ends of each partial coil 25, 26 are each electrically connected to the respective commutator plate 11 spaced one apart from the other. This means that in FIG. 3, the first end of the first partial coil 25 is connected to the sixth plate 11 and the second end of the first partial coil 25 is connected to the eighth plate 11 while the first end of the second partial coil 26 is connected to the seventh plate 11 and the second end of the second partial coil 26 is connected to the ninth plate 1. The four ends of the partial coil pair 25, 26 are thus connected to adjacent commutator plates 11 in alternating fashion. The first partial coil 25′ of a second partial coil pair 25′, 26′ is situated in the same armature slots 24 as the first partial coil 25 of the first partial coil pair 25, 26, but the coil ends according to FIG. 3 are electrically connected to the seventh and ninth commutator plates 11. The second partial coil 26′ of the second partial coil pair 25′, 26′ is thus wound into the same armature slots 24 as the second partial coil 26 of the first partial coil pair 25, 26. Its first and second ends are respectively connected to the sixth and eighth commutator plates 11.

FIG. 4 schematically depicts a partial developed view of a first embodiment of armature coils that each have two respective symmetrical partial coils. In the embodiment shown, the commutator 10 has 24 plates 11 and the armature 20 has twelve teeth 23 and twelve armature slots 24. The armature coil is wound in the fashion of a multiple circuit winding in the form of a full-pitch diametrical winding. A first partial coil pair 25, 26 is wound as follows: the winding of a first partial coil 25 is situated in a first armature slot 24 between the twelfth and first teeth 23 and in the seventh armature slot 24 between the sixth and seventh teeth 23. The winding of a second partial coil 26 is likewise situated in the first armature slot 24 between the twelfth and first teeth 23 and in the seventh armature slot 24 between the sixth and seventh teeth 23. The to ends of the first and second partial coils 25, 26 are each electrically connected to the respective commutator plate 11 spaced one apart from the other (in this case, the sixth and eighth plates). The two partial coils 25, 26 are thus connected in series. In the embodiment shown, the first partial coil 25 is wound first before the second partial coil 26 is wound. Alternatively however, it is also possible for the two partial coils 25, 26 to be wound in alternation.

A first partial coil 25′ and the second partial coil 26′ of a second partial coil pair 25′, 26′ are likewise situated in the first and seventh armature slots 24. The two ends are in turn each connected to a respective commutator plate 11 spaced one apart from the other, the first end of the second partial coil pair 25′, 26′ being connected to the seventh commutator plate 11 and the second end being connected to the ninth commutator plate 11. Correspondingly, the other armature slots 24 are also each occupied by two respective first partial coils 25 or second partial coils 26 of two partial coil pairs 25, 26, the two ends of one partial coil pair 25, 26 each being connected to the respective commutator plate 11 spaced one apart from the other (e.g. the third and fifth plates and the fourth and sixth plates, respectively). This means that the four ends of two partial coil pairs 25, 26 and 25′, 26′, which are situated in the same armature slots 24, are each connected to a respective commutator plate 11 in alternating fashion.

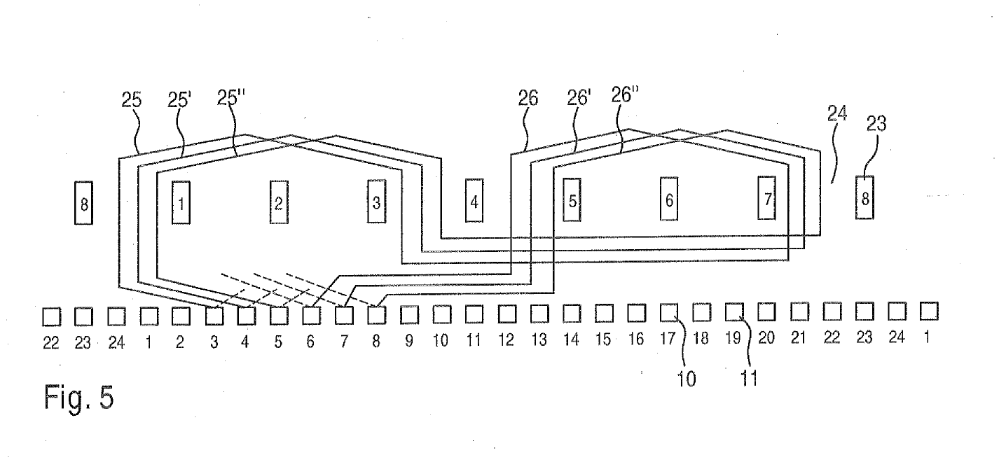

In the embodiment according to FIG. 5, a schematic depiction is given of a partial developed view of armature coils, each with two symmetrical partial coils, in which the commutator 10 has 24 plates 11 and the armature 20 has eight teeth 23 and eight armature slots 24. The number of commutator plates 11 is thus three times the number of armature slots 24. The armature coil is wound in the fashion of a multiple circuit winding in the form of a fractional pitch winding. A first partial coil pair 25, 26 is wound as follows: the winding of a first partial coil 25 is situated in a first armature slot 24 between the eighth and first teeth 23 and in the fourth armature slot 24 between the third and fourth teeth 23. The winding of a second partial coil 26 is situated in the eighth armature slot 24 between the seventh and eighth teeth 23 and in the fifth armature slot 24 between the fourth and fifth teeth 23. The two ends of the first and second partial coils 25, 26 are each electrically connected to the respective third commutator plate 11 from the other (the third and sixth plates in this case). The two partial coils 25, 26 are thus connected in series. In a manner analogous to the one in the embodiment shown in FIG. 2, the armature slots 24 into which the first partial coil 25 is wound and the armature slots 24 into which the second partial coil 26 is wound are situated opposite each other. The two partial coils 25, 26 are situated symmetrically to each other in relation to the rotation axis 13 of the armature 20 in that they run parallel to each other and the two partial coils 25, 26 are wound in opposite winding directions. In the embodiment shown, the first partial coil 25 is wound first before the second partial coil 26 is wound. Alternatively, however, it is also possible for the two partial coils 25, 26 to be wound in alternation.

A first partial coil 25′ of a second partial coil pair 25′, 26′ is likewise situated in the first and fourth armature slots 24, while the second partial coil 26′ of the second partial coil pair 25′, 26′ is likewise situated in the eighth and fifth armature slots 24. The two ends in turn are each connected to the respective third commutator plate 11 from the other, the first end of the second partial coil pair 25′, 26′ here being connected to the fourth commutator plate 11 and the second end being connected to the seventh commutator plate 11.

A first partial coil 25′ of a third partial coil pair 25″, 26″ is likewise situated in the first and fourth armature slots 24, while the second partial coil 26′ of the third partial coil pair 25″, 26″ is likewise situated in the eighth and fifth armature slots 24. The two ends in turn are each connected to the respective third commutator plate 11 from the other, the first end of the third partial coil pair 25″, 26″ in this case being connected to the fifth commutator plate 11 and the second end being connected to the eighth commutator plate 11.

Correspondingly, the additional armature slots 24 are also each occupied by three respective first partial coils 25, 25′, 25″ or second partial coils 26, 26′, 26″ of three partial coil pairs 25, 26, 25′, 26″, and 25″, 26″, with the two ends of a partial coil pair 25, 26, 25′, 26″, or 25″, 26″ being connected to the respective commutator plate 11 after the next (e.g. the third and sixth, the fourth and seventh, and the fifth and eighth). This means that the four ends of two partial coil pairs 25, 26 and 25′, 26′ that are situated in the same armature slots 24 are each connected to a respective commutator plate 11 in alternating fashion.

FIGS. 2, 3, 4, and 5 each show a respective embodiment of a series circuit and a parallel circuit of the two partial coils 25, 26. Using the principle demonstrated here of the winding of two symmetrically arranged partial coils 25, 26, it is possible to implement numerous other winding schemes.

1-9. (canceled)

10. An electrical machine, comprising:
an armature having a rotational axis,
armature slots provided in the armature,
at least one armature coil embodied as two partial coils which are arranged symmetrically to each other in relation to the rotation axis of the armature, the at least one armature coil being received by the armature slots; and
a commutator having commutator plates, wherein the number of commutator plates is an integral multiple of the number of armature slots.

11. The electrical machine as recited in claim 10, wherein the number of commutator plates is at least twice as great as the number of armature slots.

12. The electrical machine as recited in claim 10, wherein the two partial coils are situated essentially parallel to each other geometrically.

13. The electrical machine as recited in claim 11, wherein the two partial coils are situated essentially parallel to each other geometrically.

14. The electrical machine as recited in claim 10, wherein the two partial coils have a same number of windings.

15. The electrical machine as recited in claim 11 wherein the two partial coils have a same number of windings.

16. The electrical machine as recited in claim 13, wherein the two partial coils have a same number of windings.

17. The electrical machine as recited in claim 10, wherein the two partial coils are wound in opposite winding directions.

18. The electrical machine as recited in claim 11, wherein the two partial coils are wound in opposite winding directions.

19. The electrical machine as recited in claim 12, wherein the two partial coils are wound in opposite winding directions.

20. The electrical machine as recited in claim 16, wherein the two partial coils are wound in opposite winding directions.

21. The electrical machine as recited in claim 10, wherein the two partial coils are electrically connected in series.

22. The electrical machine as recited in claim 14, wherein the two partial coils are electrically connected in series.

23. The electrical machine as recited in claim 20, wherein the two partial coils are electrically connected in series.

24. The electrical machine as recited in claim 10, wherein the two partial coils are electrically connected in parallel.

25. The electrical machine as recited in claim 14, wherein the two partial coils are electrically connected in parallel.

26. The electrical machine as recited in claim 20, wherein the two partial coils are electrically connected in parallel.

27. The electrical machine as recited in claim 10, further comprising at least two brushes resting against the commutator in a sliding fashion.

28. The electrical machine as recited in claim 27, wherein three brushes rest against the commutator in a sliding fashion.
